(19) United States
(12) Patent Application Publication
(10) Pub. No.: US 2021/0035752 A1
(43) Pub. Date: Feb. 4, 2021

(54) ELECTRICAL MECHANISM

(71) Applicant: SIMON, S.A.U., Barcelona (ES)

(72) Inventors: Javier BARBERO DOMENO, Barcelona (ES); Pablo BACA CANSINO, Barcelona (ES)

(21) Appl. No.: 16/971,459

(22) PCT Filed: Mar. 15, 2019
(86) PCT No.: PCT/EP2019/056562

§ 371 Date: Aug. 20, 2020

(30) Foreign Application Priority Data
Mar. 16, 2018 (EP) 18382180.0

(51) Int. Cl. H01H 13/20; H01H 23/16; H01H 13/14

(52) U.S. Cl. CPC H01H 13/20; H01H 13/14; H01H 23/16

(57) ABSTRACT

Electrical mechanism, which has an axial axis in which are arranged: a rocking lever configured to adopt a first position and a second position of electrical connection or disconnection; a striker configured to engage with the rocking lever in the first position and in the second position (P₂); an actuating device configured to transmit an actuation force to the striker so that the striker engages with the rocking lever and changes the position thereof; and a spring configured to disengage the striker from the rocking lever once the actuation force is released. Two contact points for transmitting the actuation force are established between the striker and the actuating device of the electrical mechanism.

### FIELD OF THE INVENTION

The present invention relates to an electrical mechanism, such as an electric switch or push button, especially of the type which is actuated by a pivoting spindle that enables the position of an electric contact associated thereto to change.

### BACKGROUND OF THE INVENTION

Currently, pivoting spindle electrical mechanisms usually have the following main components: an actuating means, a striker and a rocking lever, arranged in an ordered manner on an axial axis.

Normally, the actuating means is connected to a cover or button that the user interacts with in order to apply an actuation or pushing force on the mechanism, which is transmitted to the striker by said actuating means. The action of the force on the striker causes a downward movement thereof that enables it to engage with the rocking lever. Once engaged, the rocking lever makes a pivoting movement and changes its position. The position change of the rocking lever in turn causes the position change of an electrical contact attached thereto, which causes the connection or disconnection of an electrical circuit. A spring connected to the striker enables said striker to move to its resting position once the actuation force is released, disengaging it from the rocking lever. The document CN203871246U shows an example of this type of mechanism.

For the correct operation of this type of mechanism, it is necessary that the initial downward movement of the striker until it engages with the rocking lever is as straight or vertical as possible, in other words, in the direction of the axial axis. Any deviation from said movement with respect to the axial axis can cause the striker to fail to correctly engage with the rocking lever. This usually produces a loss of sensitivity in the feel of the mechanism (perceived by the user when actuating the mechanism as a slight locking of the button) or, in the worst case, the striker remains stuck in the rocking lever, preventing the position change thereof, and therefore locking the mechanism.

Many times this problem originates from the very manufacture and/or assembly of the mechanism. Specifically, when the main components are assembled in an off-centered or misaligned manner with respect to the axial axis. The spring of the striker is usually one of the most critical elements in this sense, since the coils of the upper and lower ends thereof often do not end in complete loops, thus producing a lack of parallelism between said ends. Thus, when said ends are mounted on other elements, a slight inclination of the spring is usually produced, in other words, a slight inclination with respect to the axial axis, which causes the striker to descend deviated with respect to said axis. Therefore, the assembly of said springs requires adequate selection of the spring type and high accuracy in the assembly thereof (a difficult aspect to ensure in mass production).

The present invention solves the aforementioned problems thanks to a configuration of the pivoting spindle that achieves greater centering of the actuation force on the striker and/or greater parallelism of said force with respect to the axial axis. At the same time, said configuration optimizes the design of the main components of the pivoting spindle, reducing the amount of material needed for the manufacture thereof, reducing their size and adjusting their arrangement inside the mechanism to take up the least amount of space possible.

### DESCRIPTION OF THE INVENTION

The electrical mechanism of the present invention comprises an axial axis in which are arranged:
a rocking lever configured to adopt a first position and a second position of electrical connection or disconnection;
a striker configured to engage with the rocking lever in the first position and in the second position;
an actuating means configured to transmit an actuation force to the striker, so that said striker engages with the rocking lever and changes the position thereof; and
a spring configured to disengage the striker from the rocking lever once the actuation force is released.

The electrical mechanism of the present invention is characterized in that two contact points for transmitting the actuation force are established between the striker and the actuating means.

Preferably, the two contact points are arranged on an actuation plane perpendicular to the axial axis.

Preferably, the two contact points are arranged symmetrically with respect to the axial axis.

Preferably, the two contact points establish a distance therebetween of 0.2 mm to 4 mm. Said distance directly affects the actuation force needed to cause the rocking lever to rotate, which in turn causes the position change thereof. Specifically, the greater the distance between the contact points, the greater the actuation force needed to cause the rocking lever to rotate and vice versa.

According to a preferred embodiment, the distance between the two contact points is from 0.4 to 1 mm, and more specifically, from 0.5 mm to 0.8 mm, in order to have a minimum effect on the pushing force and on the feel of the mechanism.

The two contact points allow the actuation force to be centered on the striker and therefore have greater parallelism with respect to the axial axis, forcing the striker to move straight downward in the initial path until it engages with the rocking lever, in other words, achieving transmission of the vertical movement.

To establish the two contact points between the striker and the actuating means, the striker preferably comprises a flat receiving area configured to come in contact with the actuating means.

Preferably, the striker comprises an upper part that has a substantially rectangular shape. Firstly, this enables the width of the striker to be reduced, gaining space for the rotation thereof during its return aided by the spring after changing the position of the rocking lever. Secondly, said substantially rectangular shape enables the mass of the striker to be reduced, which in turn enables the force needed to cause the return of said striker to the resting position as well as the manufacturing costs to be reduced. Furthermore, this reduction of the return force enables springs with less elastic force, which usually offer greater parallelism, for example, a spring with 1.4 N, to be selected.

Preferably, the upper part comprises two flanges that extend laterally in opposite directions with respect to said upper part to receive an upper end of the spring. Thus, the reception of the upper end of the spring does not need the final coil of the spring to completely rest against the upper part, but only a partial reception of said coil by the two opposite sides thereof, which also entails material and cost savings with respect to the flanges or circular rims on which the outermost coils completely rest.

Preferably, the striker comprises a lower part from which two lower extensions extend symmetrically, each one being configured to engage with a position of the rocking lever.

Preferably, the striker comprises an intermediate prismatic or cylindrical part between the upper part and the lower part that is hollow on the inside, in order to further reduce the mass thereof.

To establish the two contact points between the striker and the actuating means, the actuating means preferably comprises a transmission area having two transmission points configured to come in contact with the striker.

The transmission points can be made in several ways, for example, as vertices, peaks, edges and/or ends thereof, corners, protrusions, etc., based on the constructive configuration and/or geometry of the transmission area.

Preferably, the actuating means comprises a substantially semi-spherical or curved transmission part, partially divided by a central strip that extends over the surface of said transmission part.

Preferably, the actuating means is joined to a flexible section, where said flexible section is in turn joined to a cover defining a rotation axis of said actuating means.

According to a particular embodiment, the flat receiving area is on the actuating means, while the two transmission points are on the striker.

### BRIEF DESCRIPTION OF THE DRAWINGS

What follows is a very brief description of a series of drawings that aid in better understanding the invention, and which are expressly related to an embodiment of said invention that is presented by way of a non-limiting example of the same.

FIG. 1 shows a longitudinally sectioned perspective view of the electrical mechanism of the present invention, in the resting position.

FIG. 2 shows a longitudinally sectioned perspective view of the electrical mechanism of the present invention, in the initial working position.

FIG. 3 shows a detailed view of the electrical mechanism of the present invention, in the initial working position.

FIG. 4 shows a perspective view of the striker.

FIG. 5 shows a plan view of the striker.

FIG. 6 shows a profile view of the striker.

FIG. 7 shows a bottom view of the striker.

FIG. 8 shows a bottom perspective view of the actuating means.

FIGS. 9a-9d show a sequence of the operation of the electrical mechanism of the present invention.

### DETAILED DESCRIPTION OF THE INVENTION

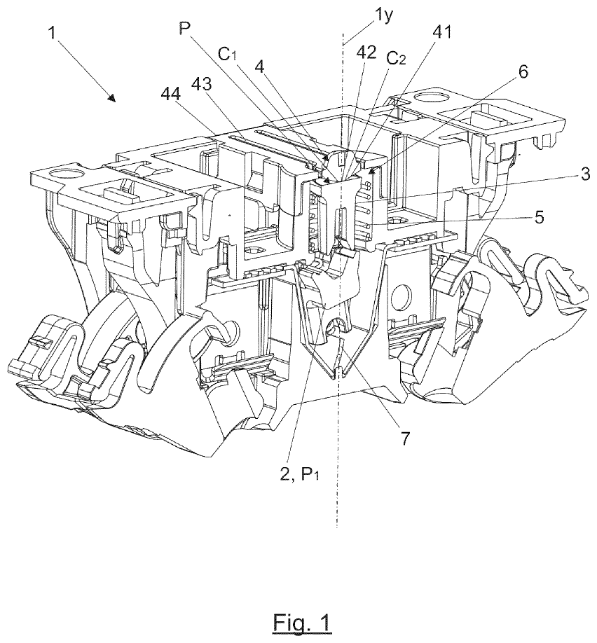

FIG. 1 shows the electrical mechanism (1) of the present invention in the resting position, before applying an actuation or pushing force (F) on a button (not shown) attached to the actuating means (4). In other embodiments, the button and the actuating means (4) can be integrated into the same part, or form part of an actuation assembly as separated parts thereof along with other elements. According to the present example, the electrical mechanism (1) constitutes an electrical switch.

As can be seen, said electrical mechanism (1) comprises an axial axis (1_{Y}) in which the following components are arranged in an orderly manner:
a rocking lever (2) that adopts a first position (P₁) of electrical connection or disconnection, and which is attached to an electrical contact (7);
a striker (3) configured to engage with the rocking lever (2) in the first position (P₁);
an actuating means (4) configured to transmit an actuation force (F) to the striker (3) so that said striker (3) engages with the rocking lever (2) and changes the same from the first position (P₁) to a second position (P₂); and
a spring (5) configured to disengage the striker (3) from the rocking lever (2) once the actuation force (F) is released and return it to the initial resting position thereof.

As observed in FIG. 1, two contact points (C₁, C₂) for transmitting the actuation force (F) are established between the striker (3) and the actuating means (4).

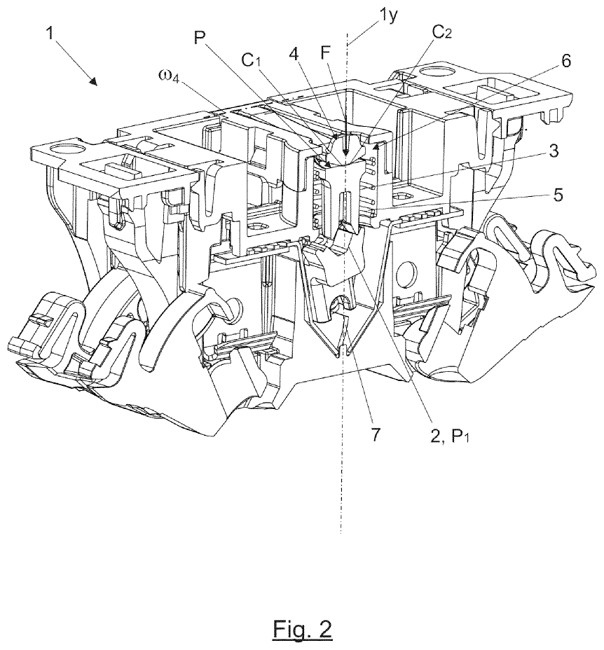

FIG. 2 shows the electrical mechanism (1) of the present invention in the initial working position, once the actuation or pushing force (F) is applied and at the exact moment when the striker (3) engages with the rocking lever (5) in the first position (P₁).

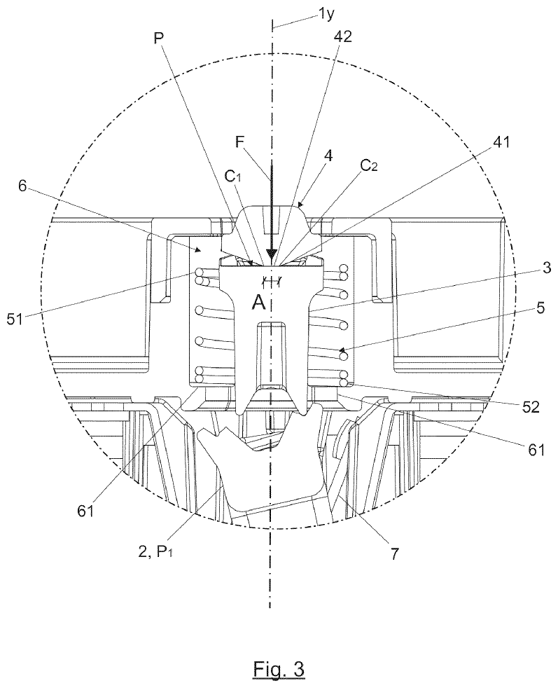

FIG. 3 shows a detailed view in which the situation shown in FIG. 2 is shown with greater clarity. As can be seen, the two contact points (C₁, C₂) allow the actuation force (F) to be centered on the striker (3) and, therefore, have greater parallelism with respect to the axial axis (1_{Y}), forcing the striker (3) to move straight downward in the initial path until it engages with the rocking lever (2).

The two contact points (C₁, C₂) are arranged on an actuation plane (P) perpendicular to the axial axis (1_{Y}), symmetrically with respect to said axial axis (1_{Y}) and establishing a distance (A) therebetween.

The two contact points (C₁, C₂) establish a distance (A) therebetween of 0.2 mm to 4 mm. According to a preferred embodiment, the distance (A) between the contact points (C₁, C₂) is from 0.4 mm to 1 mm, and more specifically, from 0.5 mm to 0.8 mm, in order to have a minimum effect on the pushing force (F) and on the feel of the mechanism (1).

FIG. 3 also shows in greater detail that the electrical mechanism (1) comprises a housing (6) arranged between the rocking lever (2) and the actuating means (4), configured to house the striker (3) and the spring (5), and which has a lower border (61) configured to receive a lower end (52) of the spring (5).

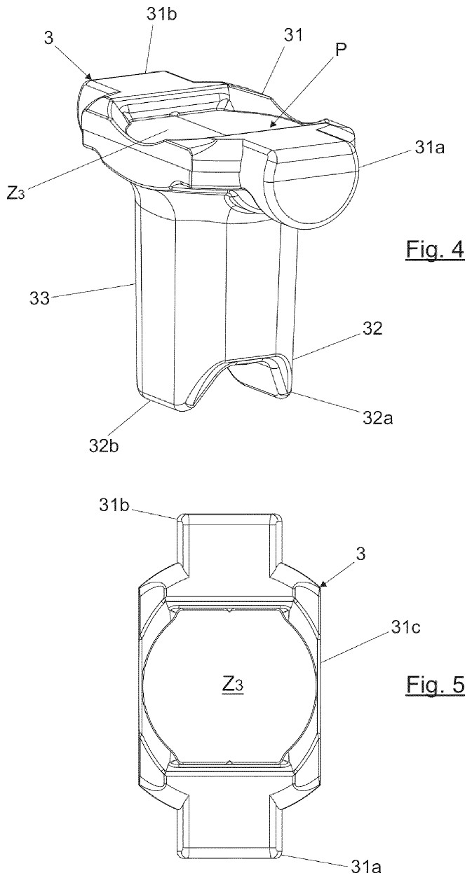

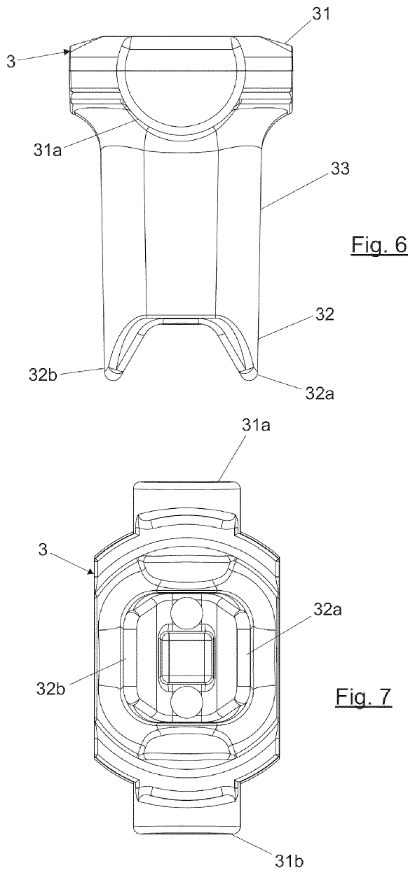

FIGS. 4-7 shows different views of the striker (3). As can be seen, to establish the two contact points (C₁, C₂) between the striker (3) and the actuating means (4), the striker (3) comprises a flat receiving area (Z₃) configured to come in contact with the actuating means (4). Said receiving area (Z₃) determines the actuation plane (P).

The striker (3) comprises an upper part (31) that has a substantially rectangular shape (31c). In turn, the upper part (31) comprises two flanges (31a, 31b) that extend laterally in opposite directions with respect to said upper part (31) to receive an upper end (51) of the spring (5) FIG. 3.

Likewise, the striker (3) comprises a lower part (32) from which two lower extensions (32a, 32b) extend symmetrically, each one being configured to engage with a position (P₁, P₂) of the rocking lever (2).

According to the present example, the striker (3) comprises an intermediate prismatic or cylindrical part (33) between the upper part (31) and the lower part (32) that is hollow on the inside.

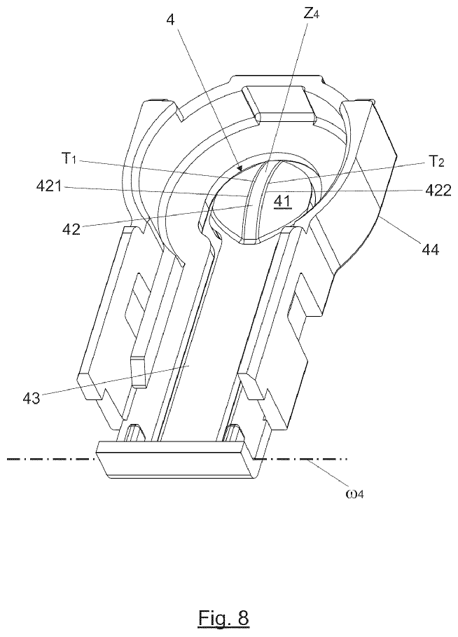

FIG. 8 shows a bottom perspective view of the actuating means (4). As can be seen, to establish the two contact points (C₁, C₂) between the striker (3) and the actuating means (4), said actuating means (4) comprises a transmission area (Z₄) having two transmission points (T₁, T₂) configured to come in contact with the striker (3).

The actuating means (4) comprises a substantially semi-spherical or curved transmission part (41), partially divided by a central strip (42) that extends over the surface of said transmission part (41).

The central strip (42) defines a first curved edge (421) and a second curved edge (422) parallel to each other on the transmission part (41), one of the two transmission points (T₁, T₂) being established on each of said curved edges (421, 422).

According to the present preferred embodiment, the two transmission points (T₁, T₂) located on the edges (421, 422) of the central strip (42) coincide with the tangential points between said edges (421, 422) and the flat receiving area (Z₃) of the striker (3).

The actuating means (4) is joined to a flexible section (43), where said flexible section (43) is in turn joined to a cover (44) defining a rotation axis (ω₄) of said actuating means (4).

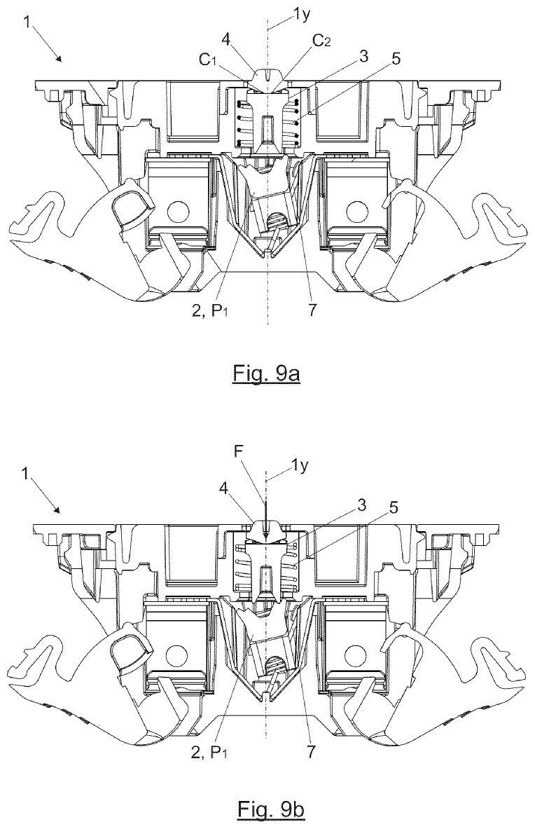

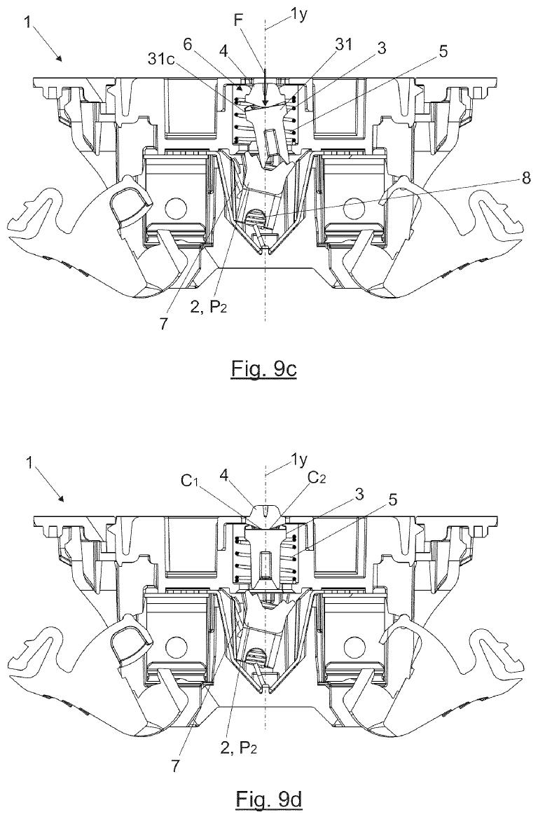

FIGS. 9a-9d show a sequence of the operation of the electrical mechanism (1) of the present invention.

Specifically, FIG. 9a shows the electrical mechanism (1) in the resting position shown in FIG. 1. As can be seen, the rocking lever (2) is in the first position (P₁) disengaged from the striker (3).

FIG. 9b shows the electrical mechanism (1) in the initial working position corresponding to FIG. 2, in other words, once the actuation or pushing force (F) is applied and at the exact moment when the striker (3) engages with the rocking lever (2) in the first position (P₁). The two contact points (C₁, C₂) allow the actuation force (F) to be centered on the striker (3) and, therefore have greater parallelism with respect to the axial axis (1_{Y}), forcing the striker (3) to move straight downward in the initial path until it engages with the rocking lever (2). This therefore prevents incorrect or inadequate engagement between the striker (3) and the rocking lever (2).

FIG. 9c shows the electrical mechanism (1) in the final working position, in which the actuation or pushing force (F) exerted on the striker (3) forces the rocking lever (2) to rotate so that it changes from the first position (P₁) to the second position (P₂). The position change (P₁, P₂) of the rocking lever (2) in turn causes the position change of an electrical contact (7) attached thereto, which causes the connection or disconnection of an electrical circuit. A second spring (8) connected to the electrical contact (7) and to the rocking lever (2) keeps the rocking lever (2) stable in each of the positions thereof (P₁, P₂), ensuring the correct connection or disconnection of the electrical circuit.

FIG. 9c also shows that the narrowness of the upper part (31) of the striker (3), due to the substantially rectangular shape (31c) thereof, allows space to be gained for the rotation of said striker (3) during its return to the resting position by the action exerted by the spring (5) after changing the position (P₁, P₂) of the rocking lever (2). This enables a smaller housing (6) to be made.

FIG. 9d shows the electrical mechanism (1) once again in the resting position, with the striker (3) ready to engage with the rocking lever (2) in the second position (P₂), repeating the process described above.

1. An electrical mechanism, which comprises an axial axis (1_{Y}) in which are arranged:
a rocking lever configured to adopt a first position (P₁) and a second position (P₂) of electrical connection or disconnection;
a striker disengaged from the rocking lever in a resting position, and configured to engage with the rocking lever in the first position (P₁) and in the second position (P₂);
an actuating means configured to transmit an actuation force (F) to the striker so that said striker engages with the rocking lever and changes the position (P₁, P₂) thereof; and
a spring configured to disengage the striker from the rocking lever once the actuation force (F) is released and return it to the resting position;
said mechanism wherein two contact points (C₁, C₂) for transmitting the actuation force (F) are established between the striker and the actuating means in an initial working position, once the actuation force (F) is applied.

2. The electrical mechanism according to claim 1, wherein the two contact points (C₁, C₂) are arranged on an actuation plane (P) perpendicular to the axial axis (1_{Y}).

3. The electrical mechanism according to claim 1, wherein the two contact points (C₁, C₂) are arranged symmetrically with respect to the axial axis (1_{Y}).

4. The electrical mechanism according to claim 1, wherein the two contact points (C₁, C₂) establish a distance (A) there between of 0.2 mm to 4 mm.

5. The electrical mechanism according to claim 4, wherein the distance (A) is from 0.4 mm to 1 mm.

6. The electrical mechanism according to claim 4, wherein the distance (A) is from 0.5 mm to 0.8 mm.

7. The electrical mechanism according to claim 1, wherein the striker comprises a flat receiving area (Z₃) configured to come in contact with the actuating means.

8. The electrical mechanism according to claim 1, t wherein the striker comprises an upper part that has a substantially rectangular shape.

9. The electrical mechanism according to claim 8, wherein the upper part comprises two flanges that extend laterally in opposite directions with respect to said upper part to receive an upper end of the spring.

10. The electrical mechanism according to claim 1, the striker comprises a lower part from which two lower extensions extend symmetrically, each one being configured to engage with a position (P₁, P₂) of the rocking lever.

11. The electrical mechanism according to claim 1, wherein actuating means comprises a transmission area (Z₄) having two transmission points (T₁, T₂) configured to come in contact with the striker.

12. The electrical mechanism according to claim 1, wherein the actuating means comprises a substantially semi-spherical or curved transmission part, partially divided by a central strip that extends over the surface of said transmission part.

13. The electrical mechanism according to claim 11, wherein the central strip defines a first curved edge and a second curved edge parallel to each other on the transmission part, one of the two transmission points (T₁, T₂) being established on each of said curved edges.

14. The electrical mechanism according to claim 1, wherein the actuating means is joined to a flexible section, where said flexible section is in turn joined to a cover a rotation axis (ω₄) of said actuating means.

15. The electrical mechanism according to claim 1, further comprising a housing arranged between the rocking lever and the actuating means, configured to house the striker and the spring, and which has a lower border configured to receive a lower end of the spring.
